(19) United States
(12) Patent Application Publication
(10) Pub. No.: US 2009/0168714 A1
(43) Pub. Date: Jul. 2, 2009

(54) RADIO COMMUNICATION APPARATUS AND CONTROL METHOD FOR RADIO COMMUNICATION SYSTEM

(75) Inventors: Yoshinori TANAKA, Kawasaki (JP); Yoshihiro KAWASAKI, Kawasaki (JP); Kazuhisa OBUCHI, Kawasaki (JP); Yoshiharu TAJIMA, Kawasaki (JP); Akira ITO, Kawasaki (JP); Yoshiaki OHTA, Kawasaki (JP); Jianming WU, Kawasaki (JP); Katsumasa SUGIYAMA, Kawasaki (JP)

Correspondence Address: MYERS WOLIN, LLC, 100 HEADQUARTERS PLAZA, North Tower, 6th Floor, MORRISTOWN, NJ, 07960-6834, US

(73) Assignee: FUJITSU LIMITED, Kawasaki-shi (JP)

(21) Appl. No.: 12/340,803

(22) Filed: Dec. 22, 2008

(30) Foreign Application Priority Data
Dec. 27, 2007 (JP) 2007-335565

(51) Int. Cl. H04W 4/00

(52) U.S. Cl. 370/329

(57) ABSTRACT

A control method for a radio communication system, wherein a first apparatus transmits a radio signal used to select a radio resource to a second apparatus and when the second apparatus receives a radio signal for requesting allocation of a radio resource from the first apparatus, the second apparatus selects a radio resource to be allocated to the first apparatus based on a radio signal used to select the radio resource and transmits information of the selected radio resource to the first apparatus Consequently, the first apparatus transmits transmission data by using the radio resource specified by the information. The method includes regulating transmission of the radio signal used to select the radio resource to be allocated when the first apparatus receives a particular signal from the second apparatus.

### CROSS-REFERENCE TO RELATED APPLICATIONS

This application is based upon and claims the benefit of priority of the prior Japanese Patent Application No. 2007-335565, filed on Dec. 27, 2007, the entire contents of which are incorporated herein by reference.

### FIELD

Certain aspects of the present invention discussed herein are related to a radio communication apparatus, which conducts radio communication and control thereof.

### BACKGROUND

There are various known communication methods for using radio communication as a communication means.

The following is a description of Long Term Evolution (LTE) as an example of a radio communication system.

FIG. 1 is a diagram describing a data transmission (uplink transmission) flow from a mobile station as an example of a radio communication apparatus to a base station as another example of a radio communication apparatus.

To communicate with the base station, the mobile station first transmits a random access signal by using a radio resource shared with another mobile station for signal transmission. When receiving the random access signal, the base station transmits a response signal to the mobile station to establish uplink synchronization and allocates a radio resource for transmitting a scheduling request (SR) signal for requesting radio resource allocation and a (broadband) pilot signal (SRS: Sounding Reference Signal) to be transmitted broadly in a certain frequency band in which the radio resource may be allocated. If the radio resource for transmitting the scheduling request signal is already allocated to the mobile station, the above-described process may be omitted.

When data required to be transmitted is generated (arrives at a data processor) in the mobile station to which the radio resource for transmitting the scheduling request signal is allocated, the mobile station transmits the scheduling request signal (SR) to the base station as described in FIG. 1. By receiving the SR, the base station determines (selects) an uplink radio resource to be allocated to this mobile station, and then transmits to the mobile station allocation information (up-link (UL) allocation grant) of the radio resource used to notify the mobile station of the selected radio resource information (e.g. frequency). Therefore, the mobile station transmits the generated (arrived) transmission data by using the uplink resource specified by the notified radio resource information.

Since the mobile station is also allocated the radio resource for transmitting the SRS, the mobile station transmits the SRS by using this radio resource. The base station may tell which frequency part is preferable to select for the radio resource to be allocated to the mobile station by observing a reception state of the SRS. Thus, the base station allocates the radio resource corresponding to a frequency part having, for example, the best reception quality.

When the uplink data is transmitted from the mobile station, the base station transmits reception result information (ACK/NACK). Here, the ACK (Acknowledgement response) shows that the data is received normally (reception without failure). The NACK (Negative Acknowledgement response) shows that the data is not received normally (reception with failure).

To transmit the NACK, the uplink radio resource for retransmitting may be newly allocated to the mobile station. To transmit the ACK, the uplink radio resource for transmitting a next new data may be allocated to the mobile station.

Therefore, when receiving the ACK, the mobile station transmits new data by using the radio resource allocated to the mobile station. When receiving the NACK, the mobile station transmits retransmission data by using the radio resource allocated to the mobile station.

When the uplink data is transmitted, the reception result information (ACK/NACK) concerning downlink data reception may be multiplexed on the uplink data to be transmitted. Alternatively, the reception result information may be transmitted separately from the uplink data.

For example, if there is no uplink data, the reception result information may be transmitted through a physical uplink control channel (PUCCH). If there is uplink data, the data may be time-multiplexed with the reception result information and transmitted by using the radio resource allocated by the allocation information (UL allocation grant) of the radio resource.

The following describes the downlink transmission with reference to FIG. 2.

FIG. 2 is a diagram describing a processing flow of data transmission (downlink transmission) from the base station to the mobile station.

As illustrated in FIG. 2, if there is downlink data to be transmitted, the base station first transmits a control signal (downlink scheduling information) that includes the radio resource for transmitting the downlink data to the mobile station as a destination station and information of a transmission format (i.e. a modulation method, an encoding rate etc.) through a physical downlink control channel (PDCCH). There is a plurality of physical downlink control channels. The mobile station receives each control channel to determine whether or not there is a control signal addressed to the mobile station. For example, the mobile station performs the determination depending on whether or not ID information of the mobile station is included. If the mobile station detects the control signal addressed to the mobile station, the mobile station receives a physical downlink shared channel (PDSCH) based on the allocation information of the radio resource and transmission format information included in the control signal, and then obtains the downlink data.

If the downlink data is correctly decoded, the mobile station transmits an ACK signal to the base station. If not, the mobile station transmits a NACK signal to the base station. When receiving the ACK signal, the base station then transmits new data. When receiving the NACK signal, the base station transmits retransmission data.

Since the mobile station also observes (measures) the transmission quality of the downlink channel, the mobile station transmits an observation result as a channel quality indicator (CQI) to the base station.

When receiving the CQI, the base station selects a radio resource and selects a transmission format or the like, to provide a high reception quality to the mobile station.

The technique related to the above-described LTE is described in detail in 3GPP TS36.300 and 3GPP TS36.211.

As with the uplink data transmission described above, a radio communication apparatus requests the allocation of a radio resource for transmitting the data to another radio communication apparatus and then the other radio communication apparatus responds to this and follows procedures for allocating the radio resource so that the transmission control may be performed smoothly.

However, even though the request for allocating the radio resource is received, there may not be a radio resource to be allocated. In addition, the allocation period may be continued.

In this case, even though the signal for requesting the allocation of the radio resource is transmitted, a radio communication apparatus is not allocated the radio resource (in a silent state where no response is given from the base station) and the radio communication apparatus again transmits the signal for requesting the allocation of the radio resource. Thus, traffic may be unnecessarily increased; battery usage of the mobile station may be wasted; or interference may be increased.

A similar situation may occur in the LTE described above.

FIG. 3 is a flow illustrating uplink radio resource allocation and data transmission in the LTE. In this example, the mobile station periodically transmits the SRS and transmits the SR by generation (data arrives at a data processor) of an uplink data packet. However, the base station can not allocate any radio resource and goes to a silent state. Therefore, the mobile station repeats periodic transmission of the SRS and repeatedly transmits the SR. Then a third SR is finally received by the base station. Consequently, the base station allocates an uplink radio resource to the mobile station for transmitting a buffer status report (BSR) signal.

The base station adjusts the width of the frequency band of the uplink radio resource for the uplink data transmission to be allocated depending on a data amount shown by the BSR. The base station then notifies the mobile station of the allocated radio resource. The mobile station transmits the data by using the allocated radio resource.

The signal for requesting the allocation of the radio resource may be transmitted again in the LTE because the radio resource is not allocated as described above.

Specifically, such a problem may appear in a base station or the like corresponding to a femtocell whose capacity for radio resource allocation is small.

### SUMMARY

It is an object in an aspect of the invention to enable the control of a signal transmission for requesting a radio resource allocation.

It is another object in an aspect of the invention to enable the control of a signal transmission used to select a radio resource.

According to one aspect of the invention, a control method for a radio communication system, wherein a first radio communication apparatus transmits a radio signal used to select a radio resource to a second radio communication apparatus, and when the second communication apparatus receives a radio signal for requesting allocation of a radio resource from the first radio communication apparatus, the second radio communication apparatus selects a radio resource to be allocated to the first radio communication apparatus based on a radio signal used to select the radio resource and transmits information of the selected radio resource to the first radio communication apparatus, and the first radio communication apparatus transmits transmission data by using the radio resource specified by the information. The control method includes regulating transmission of the radio signal used to select the radio resource to be allocated when the first radio communication apparatus receives a particular signal from the second radio communication apparatus.

Preferably the radio signal used to select the radio resource corresponds to either a pilot signal transmitted by using a plurality of frequencies in the particular frequency band or a radio signal which indicates a buffer status in the first radio communication apparatus.

Preferably the second radio communication apparatus should transmit the particular signal in response to a reception of the radio signal for requesting allocation of the radio resource.

Preferably the second radio communication apparatus should transmit the particular signal as broadcast information.

Preferably the particular signal corresponds to a signal transmitted in a state in which the radio resource cannot be allocated and when the first radio communication apparatus receives a signal notifying that a radio resource can be allocated from the second radio communication apparatus, the first radio communication apparatus releases the regulating the transmission of the radio signal used to select the radio resource.

Wherein the particular signal corresponds to a signal transmitted in a state in which the radio resource cannot be allocated and includes a prospective timing at which state the radio resource cannot be allocated changes and when the first radio communication apparatus receives broadcast information indicating that a radio resource can be allocated from the second radio communication apparatus at the prospective timing, the first radio communication apparatus releases the regulating transmission of the radio signal used to select the radio resource.

Preferably the signal used to select the radio resource corresponds to a pilot signal transmitted by using a plurality of frequencies in the particular frequency band and when the first radio communication apparatus receives the particular signal from the second radio communication apparatus, the first radio communication apparatus controls the regulation of the transmission signal for requesting allocation of a radio resource and the regulation is released at the same time or at a prior time interval as the regulation of the transmission of the signal for requesting allocation of the radio resource, or is released at the same time as transmission of a report signal of the buffer amount or at an earlier interval than that time.

According to one aspect of the invention, a radio communication apparatus corresponding to a first radio communication apparatus in a radio communication system in which the first radio communication apparatus transmits a radio signal used to select a radio resource to a second radio communication apparatus, and when the second radio communication apparatus receives a radio signal for requesting allocation of a radio resource, the second communication apparatus selects a radio resource to be allocated from a particular frequency band based on the radio signal used to select the radio resource. Consequently, the first radio communication apparatus transmits transmission data by using the radio resource specified by the information of the radio resource. The radio communication apparatus comprises a controller configured to regulate the signal used to select a radio resource to be allocated when the radio communication apparatus receives a particular signal from the second radio communication apparatus.

According to one aspect of the invention, a radio communication apparatus corresponding to a second radio communication apparatus in a radio communication system in which a first radio communication apparatus transmits a radio signal used to select a radio resource, and when the second radio communication apparatus receives a radio signal for requesting allocation of a radio resource from the first radio communication apparatus, the second radio communication apparatus selects a radio resource to be allocated based on the radio signal used to select the radio resource. Consequently, the second radio communication apparatus transmits information of the selected radio resource to the first radio communication apparatus and the first radio communication apparatus transmits transmission data by using the radio resource specified by the information of the radio resource. The radio communication apparatus comprises a transmitter configured to transmit a certain signal to the first radio communication apparatus, wherein the signal used to select the radio resource to be allocated is not received from the first radio communication apparatus while the first radio communication apparatus controls the regulation of the radio signal used to select the radio resource to be allocated.

According to one aspect of the invention, a control method in a radio communication system in which a first radio communication apparatus transmits a radio signal for requesting allocation of a radio resource to a second radio communication apparatus, and when the second radio communication apparatus receives the radio signal for requesting allocation of a radio resource from the first radio communication apparatus, the second radio communication apparatus selects a radio resource to be allocated and transmits information of the selected radio resource to the first radio communication apparatus. Consequently, the first radio communication apparatus transmits transmission data by using the radio resource specified by the information of the radio resource. The control method includes transmitting a particular signal from the second radio communication apparatus according to an allocation state of the radio resource, and regulating the transmission of the radio signal for requesting allocation of the radio resource when the first radio communication apparatus receives a particular signal from the second radio communication apparatus.

Preferably the second radio communication transmits the particular signal when there is no radio resource that can be newly allocated.

Preferably the regulating the transmission of the radio signal for requesting allocation of the radio resource is not performed until a limit based on any time included in one or a plurality of time candidates.

Preferably the particular signal includes timing information at which the regulating transmission should be released and the second radio communication apparatus releases the regulating transmission of the radio signal for requesting allocation of the radio resource according to the timing information.

Preferably the second radio communication apparatus transmits the particular signal in response to a reception of either a random access signal or a scheduling request signal.

Preferably the signal for requesting allocation of the radio resource corresponds to either a random access signal or a scheduling request signal.

According to one aspect of the invention, a radio communication apparatus corresponding to a first radio communication apparatus in a radio communication system in which the first radio communication apparatus transmits a radio signal for requesting allocation of a radio resource to a second radio communication apparatus and when the second communication apparatus receives a radio signal for requesting allocation of a radio resource from the first radio communication apparatus, the second radio communication apparatus selects a radio resource to be allocated and then transmits information of the selected radio resource to the first radio communication apparatus. Consequently, the first radio communication apparatus transmits transmission data by using the radio resource specified by the information of the radio resource. The radio communication apparatus includes a receiver configured to receive a particular signal transmitted from the second radio communication apparatus according to an allocation state of the radio resource; and a controller configured to regulate the signal for requesting allocation of the radio resource when the certain signal is received by the receiver.

According to one aspect of the invention, a radio communication apparatus corresponding to a second radio communication apparatus in a radio communication system in which a first radio communication apparatus transmits a radio signal for requesting allocation of a radio resource to the second radio communication apparatus, and when the second radio communication apparatus receives a radio signal for requesting allocation of a radio resource, the second radio communication apparatus selects a radio resource to be allocated and then transmits information of the selected radio resource to the first radio communication apparatus. Consequently, the first radio communication apparatus transmits transmission data by using the radio resource specified by the information of the radio resource. The radio communication apparatus includes a transmitter configured to transmit a particular signal according to an allocation state of the radio resource, and a receiver configured not to receive a signal for requesting allocation of a radio resource from the first radio communication apparatus while the first radio communication apparatus regulates transmission of a radio signal for requesting allocation of a radio resource in response to reception of the particular signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a processing flow of data transmission from a mobile station to a base station;

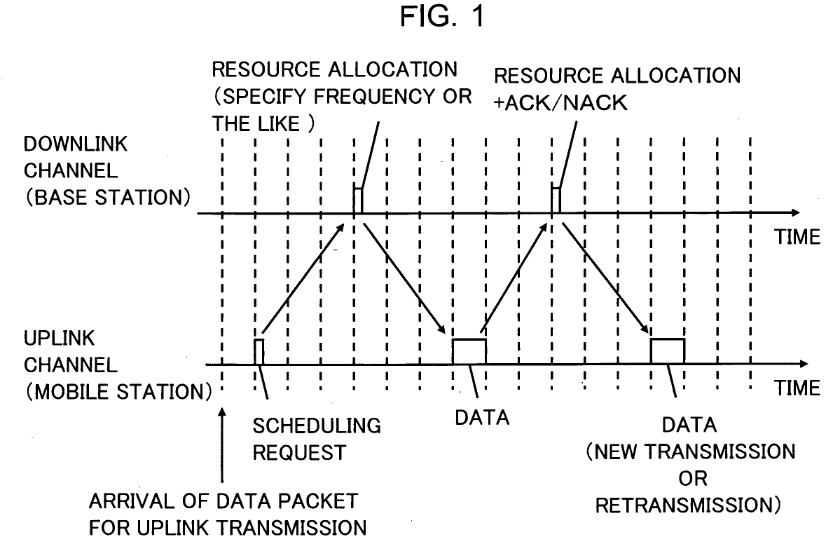

FIG. 2 illustrates a processing flow of the data transmission from the base station to the mobile station;

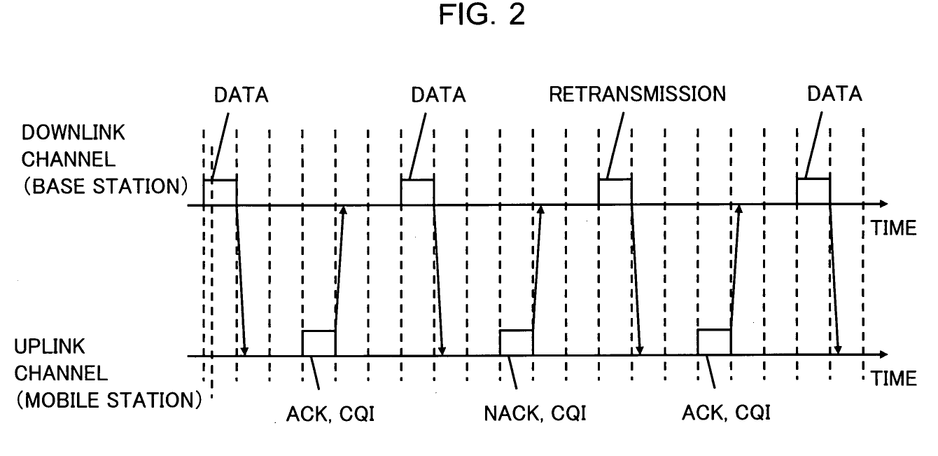

FIG. 3 illustrates a flow of uplink resource allocation and data transmission;

FIG. 4 is a configuration example of a base station 1;

FIG. 5 is a configuration example of a mobile station 2;

FIG. 6 illustrates a flow example of uplink resource allocation and data transmission (1);

FIG. 7 illustrates a configuration example of a frame used for uplink transmission (the case when there is no transmission data);

FIG. 8 illustrates a configuration example of a frame used for downlink transmission (1);

FIG. 9 illustrates a configuration example of a radio frame used for uplink transmission (the case when there is transmission data);

FIG. 10 illustrates a flow of uplink resource allocation and data transmission (2);

FIG. 11 illustrates a flow of uplink resource allocation and data transmission (3);

FIG. 12 illustrates a flow of uplink resource allocation and data transmission (4);

FIG. 13 illustrates a flow of uplink resource allocation and data transmission (5);

FIG. 14 is a configuration example of a frame used for downlink transmission (2); and

FIG. 15 illustrates a flow example of uplink resource allocation and data transmission (6).

### DETAILED DESCRIPTION OF THE PREFERRED EMBODIMENTS

Embodiments for carrying out the present invention are described with reference to the figures.

In this embodiment, in a control method in which a first radio communication apparatus transmits a radio signal for requesting allocation of a radio resource and when a second communication apparatus receives a radio signal for requesting allocation of a radio resource from the first radio communication apparatus, the second radio communication apparatus selects a radio resource to be allocated and transmits information of the selected radio resource to the first radio communication apparatus. Consequently, the first radio communication apparatus transmits transmission data by using the radio resource specified by the information of the radio resource. The method including that the second radio communication apparatus transmits a particular signal according to the allocation state of the radio resource and the first radio communication apparatus regulates the transmission of a radio signal for requesting allocation of a radio resource when the first radio communication apparatus receives the particular signal from the second radio communication apparatus.

Therefore, by transmitting the particular signal, it is possible to control the transmission of the signal for requesting allocation of the radio resource. Furthermore, it is possible to avoid traffic pressure and so on.

The following is a description of the above-described LTE as an example of the radio communication system that enables data transmission by allocating a radio resource depending on a request for allocating a radio resource. The same process may be performed on other radio communication systems by including a function for transmitting the particular signal. When the LTE is applied to other systems, a processing method of a transmitting processing unit and a receiving processing unit may be changed according to the systems.

The LTE has a configuration for performing transmission/reception of a radio signal by using Single Carrier Frequency Division Multiple Access (SC-FDMA) for uplink and Orthogonal Frequency Division Multiple Access (OFDMA) for downlink.

### “Configuration of the Radio Communication Apparatus (Base Station 1)”

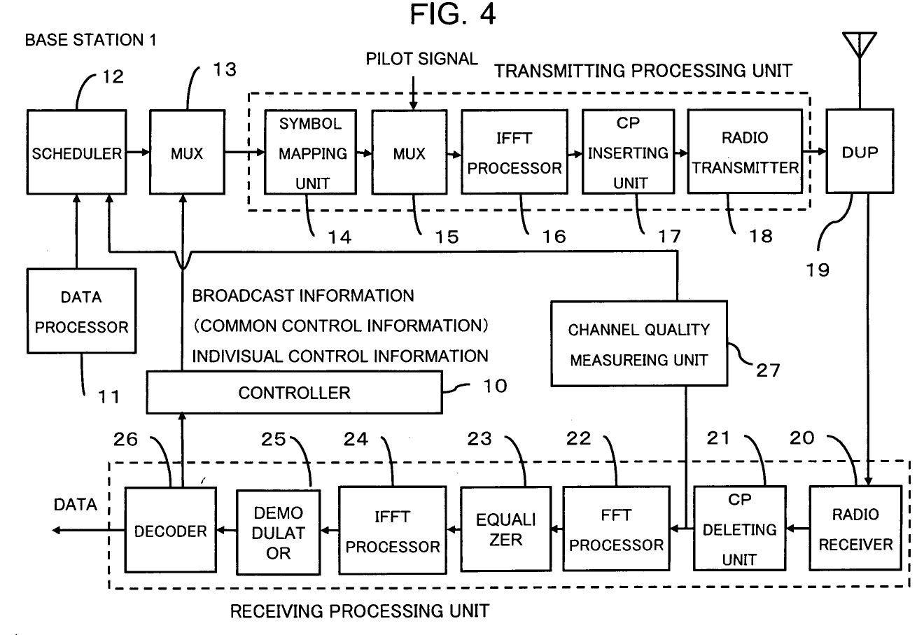

FIG. 4 shows a configuration example of the base station 1 as an example of the radio communication apparatus.

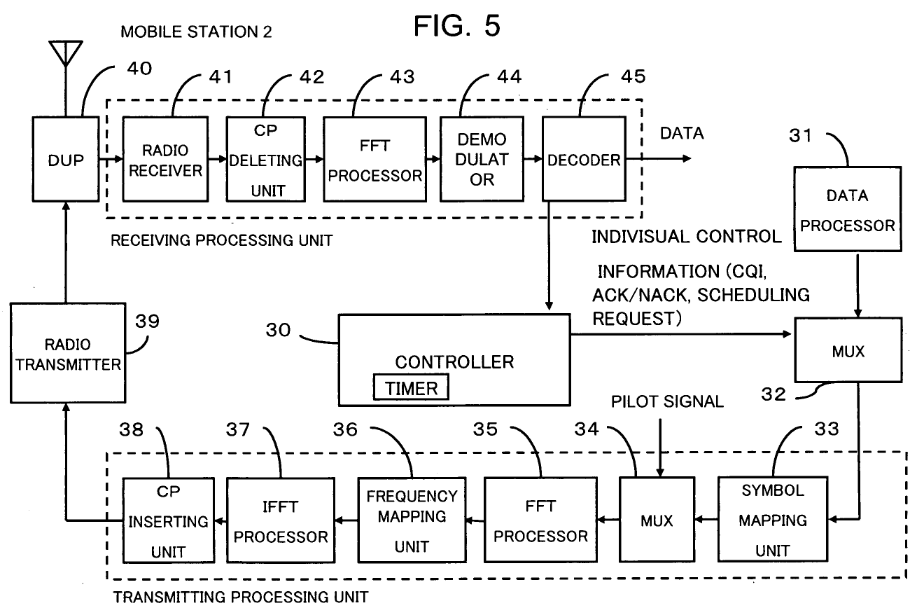

As depicted in FIG. 4, numeral 10 indicates a controller that controls each unit. The controller 10 obtains information (such as control information) received from a mobile station 2 (FIG. 5) as an example of the radio communication apparatus by receiving processing units (20 to 26). By generating and transmitting a control signal (broadcast information and individual control information) to the transmitting processing units (14 to 18), the controller 10 performs transmission to the mobile station 2. A particular signal (for example, zero allocation information and back-off time), allocation information of the selected radio resource (UL allocation Grant), and reception result information (ACK/NACK) are typical examples of the control signal to be generated.

Numeral 11 indicates a data processor. Numeral 12 indicates a scheduler. The data processor 11 gives data that is given from an upper side of a connected mobile network and addressed to a plurality of mobile stations including the mobile station 2, to the scheduler 12. The scheduler 12 controls the order for transmitting data to each mobile station to determine a transmission schedule and then relays the transmission data to a multiplexer 13 so that the data addressed to each mobile station is transmitted according to the determined schedule. It is preferable that the transmission data is given error-correcting encoding (turbo encoding or the like) before transmission.

The scheduling may be performed by using the CQI information reported from the mobile station and various parameters such as QOS (Quality of Service).

Numeral 13 indicates a multiplexer. The multiplexer 13 multiplexes the control information (that includes a particular signal described later) generated by the controller 10 with the data and then transmits this information to a symbol mapping unit 14.

The symbol mapping unit 14 performs mapping of the control signals to a particular signal points. A multiplexer 15 multiplexes the signal that is given the mapping processing and a pilot signal which is used by mobile station 2 to measure a CQI which then relays the signal as a signal corresponding to a plurality of sub-carriers to an IFFT processor 16.

The Inverse Fast Fourier Transformation (IFFT) processor 16 performs the conversion processing from a frequency domain to a time domain on the signal corresponding to each sub-carrier before outputting the transmission signal.

A Cyclic Prefix (CP) inserting unit 17 copies a part of the last part of the symbol of the transmission signal to a symbol head part to form a so-called guard interval (GI) which then relays the guard interval to a radio transmitter 18.

Numeral 18 indicates a radio transmitter. The radio transmitter 18 performs frequency conversion processing (up convert), amplification processing and so on as necessary for radio transmission and then transmits the radio signal from an antenna through a DUP 19 as a transmission/reception duplexer. A plurality of antennas may be provided for performing Multi Input Multi Output transmission and reception of radio signals or for constructing an array antenna system that adjusts a beam direction by weighting control for transmission and/or reception of radio signal.

The signal received from the antenna is relayed to a radio receiver 20.

The radio receiver 20 performs the removal of unnecessary wave signals, amplification processing and the like on the received signal and then transmits the signal to a CP deleting unit.

Numeral 21 indicates a CP deleting unit. The CP deleting unit 21 removes the CP added by the mobile station 2 before giving the signal to an FFT processor 22. The Fast Fourier Transformation (FFT) processor 22 converts the received signal of the time domain into a signal of the frequency domain. Then the signal is equalized by an equalizer 23 to correct distortion and is then given to the IFFT processor 24.

The IFFT processor 24 again converts the signal of the frequency domain into a signal of the time domain and then gives the signal to a demodulator 25.

The demodulator 25 demodulates the received signal and then relays the signal to a decoder. A decoder 26 performs decoding processing (for example, error correcting decoding process such as turbo decoding) on the demodulated signal, and then outputs a decoded result. The data is transferred to a (mobile) network side. The control signal is relayed to the controller 10. A signal for requesting allocation of a radio resource (e.g. SR), a signal used for allocating a radio resource (e.g. SRS and BSR), reception result information (ACK/NACK), reception quality information (CQI) and so on are provided as examples of a typical control signal relayed to the controller 10.

Numeral 27 indicates a channel quality measuring unit. The channel quality measuring unit 27 measures reception quality of the received signal received by the radio receiver 20 and then relays a measurement result to the scheduler 12.

Next, referring to FIG. 5, a description is made of an example configuration of the mobile station 2 as an example of the radio communication apparatus.

### “Configuration of Radio Communication Apparatus (Mobile Station 2)”

FIG. 5 illustrates a possible configuration of the mobile station 2 as an example of the radio communication device.

In FIG. 5, numeral 30 indicates a controller that controls each unit. The controller 30 obtains information (such as control information) received from the base station 1 as an example of the radio communication apparatus by the receiving processing units (41 to 45). Further, by generating a control signal (individual control information) and then giving the control signal to the transmitting processing units (33 to 38), the controller 30 transmits the control signal to the base station 1. A signal for requesting allocation of a radio resource (e.g. SR), a signal used for allocating the resource allocation (e.g. BSR), reception result information (ACK/NACK), reception quality information (CQI) and soon are given as typical examples of the control signal to be generated. Further, the error correcting encoding processing may be performed on the control signal before transmission.

Numeral 31 indicates a data processor. The data processor 31 relays the information input by an input unit (not shown) or data generated inside the apparatus to a multiplexer 32. It is preferable that the data is given the error correcting encoding processing such as turbo encoding before transmission.

The multiplexer 32 multiplexes the control signal given from the controller 30 and the data from the data processor 31 and then relays the data to a symbol mapping unit 33.

The symbol mapping unit 33 performs mapping of the control signals to the particular signal points. A multiplexer 34 multiplexes the signal provided by the mapping processing and the pilot signal such as an SRS (may be considered as a kind of control signal) and then relays the signal to an FFT processor 35.

The FFT processor 35 converts the input signal from the signal of the time domain into the signal of the frequency domain and then relays the output to a frequency mapping unit 36.

The frequency mapping unit 36 performs frequency mapping to locate the signal in the particular radio resource (frequency band) allocated to the base station 1.

Numeral 37 indicates an IFFT processor. The IFFT processor 37 converts the signal that is given the frequency mapping into a signal of the time domain and then relays the signal to a CP inserting unit 38. As with the base station 1, the CP inserting unit 38 relays the transmission signal to a radio transmitter 39 by inserting a CP.

The radio transmitter 39 performs up conversion, amplification processing as necessary for the given transmission signal and then transmits the transmission signal as a radio signal from the antenna through a DUP 40 as a transmission/reception duplexer.

In this manner, the mobile station 2 transmits the radio signal corresponding to an SC-FDMA system.

The received signal received from the base station 1 by the antenna is given to a radio processing unit 41 through the DUP 40.

The radio receiver 41 performs unnecessary radio wave removal, necessary amplification processing or the like on the received signal, and then relays the received signal to a CP deleting unit 42.

The CP deleting unit 42 deletes a CP of the received signal and then relays the signal to an FFT processor 43.

The FFT processor 43 converts the received signal in which the CP is removed into a signal of the frequency domain and then outputs the signal.

Numeral 44 indicates a demodulator. The demodulator 44 performs demodulation processing on the signal corresponding to each sub carrier from the FFT processing unit 43 and then relays the demodulated signal to a decoder 45.

The decoder 45 performs error correcting decoding processing such as turbo decoding on the demodulated signal, relays the data to an output unit (not shown), and relays the data to a data processor 31.

The decoder 45 also provides a control signal to the controller 30.

The particular signal (e.g. zero allocation information and a back-off time), allocation information of a selected radio resource (UL allocation Grant), reception result information (ACK/NACK) and so on are given as typical examples of the control signal.

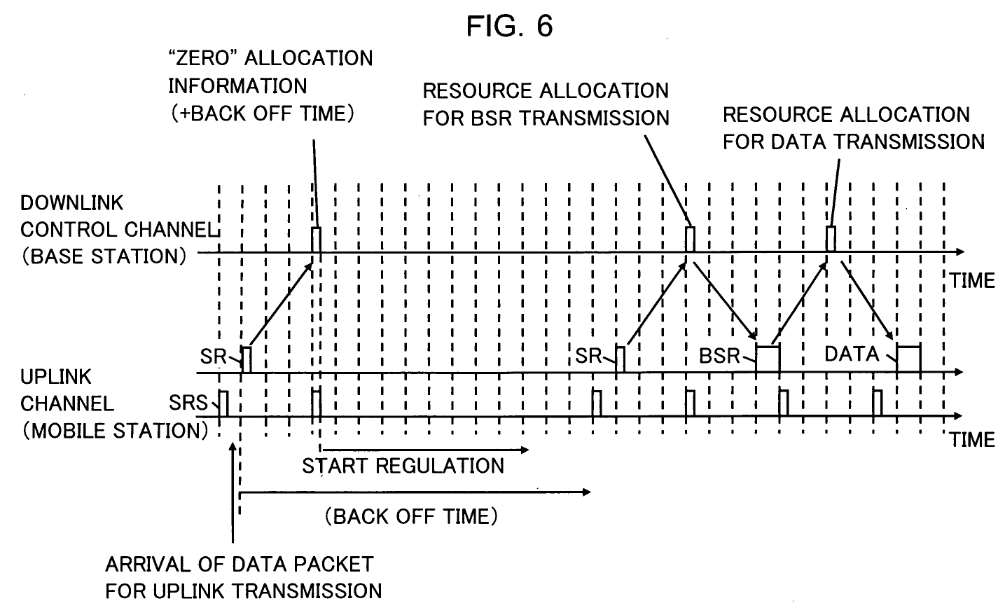

Next, referring to FIG. 6, a description is provided of the radio communication performed between the base station 1 and the mobile station 2.

### “Flow of Processing (1)”

FIG. 6 illustrates a flow example of uplink resource allocation and data transmission (1).

In this example, the mobile station 2 is in a state where the mobile station 2 can transmit uplink control signals to the base station 1. For example, the mobile station 2 has established uplink synchronization with the base station 1 by transmitting a random access signal. Subsequently, the mobile station is in a state in which the mobile station 2 may transmit each control signal by using the specified uplink channel.

The mobile station 2 transmits an SRS signal through the uplink channel. The SRS signal is a signal that is used when the uplink radio resource is allocated by the base station 1. For example, the SRS may be a known pilot signal transmitted by using a plurality of frequencies in a particular band (B: band width=BW1) where the base station may allocate the radio resource. This signal has a wide bandwidth in the a particular band B, which is useful in selecting the radio resource by the base station 1.

In this example, the mobile station 2 periodically transmits the SRS in a particular time period. However, the SRS transmission may be limited to the same time as the SR. The SRS is transmitted in response to the SR. However, the SRS may be transmitted earlier than the SR.

The mobile station 2 periodically transmits the SRS as shown in FIG. 6. However, when uplink packet data is generated (uplink packet data arrives) in the data processor 31, the controller 30 transmits the SR to the base station 1 by generating and relaying the SR to the multiplexer 32.

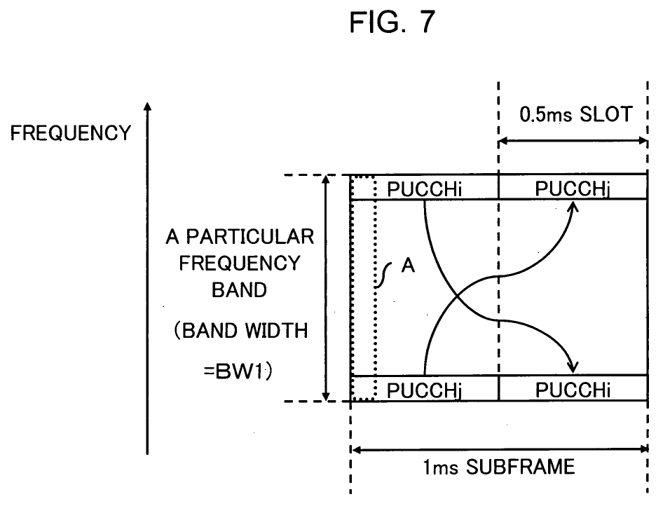

FIG. 7 illustrates a configuration example of a frame used for uplink transmission.

As an example, a radio frame with a length of 10 ms is one radio frame. One radio frame is divided into 20 slots of 0.5 ms. Two slots are included in one sub-frame.

PUCCHi and PUCCHj are two up control channels, and each frequency hop occurs at a border of the slot that may be in the middle of a 1 ms sub-frame.

The mobile station 2 is allocated either the PUCCHi or the PUCCHj as an up control channel from the base station 1.

For example, if the mobile station 2 is allocated the PUCCHj, the mobile station 2 transmits the SR by using this PUCCHj. The SR includes a signal for requesting allocation of the radio resource for uplink data transmission.

The SRS may be transmitted by using the radio resource of the part included in a dotted frame shown in FIG. 7-A (for example, one symbol from the head of the radio sub-frame). At this time, the SRS signal may be transmitted over the particular frequency band. Furthermore, the SRS signal may be divided into a plurality of frequencies to be transmitted according to a particular rule. The frequency used for transmitting the PUCCH may be excluded to transmit the SRS signal.

To transmit the SRS at the same time as when the PUCCH is transmitted, it is possible to shorten the length of the PUCCH of the first slot by shifting the start time of the PUCCH of the first slot to a later point of time or just not transmitting the data in an overlapped part.

The receiving processing unit of the base station 1 receives the SR transmitted from the mobile station 2 and performs a decoding process on the SR if necessary and relays the data included in the SR to the controller 10. When the base station 1 receives the SRS, the channel quality measuring unit 27 that measures a channel quality specifies the frequency band in which reception is relatively good of the particular frequency band and notifies this frequency information to the scheduler 12.

By receiving the SR, the controller 10 recognizes that the mobile station 2 requests allocation of uplink radio resource and then performs radio resource allocation processing.

In this case, however, if all of the uplink radio resource is already allocated to other mobile stations, or for example if the allocation state of the radio resource shows that it is difficult to allocate the radio resource to the mobile station 2, the controller 10 generates a particular signal, relays that particular signal to the multiplexer 13 and then transmits the signal to the mobile station 2.

The particular signal is a signal in which the mobile station is capable of performing certain operations by detecting this particular signal.

In this case, the content of the particular signal indicates that the radio resource allocation may not be performed (“zero” radio resource is allocated).

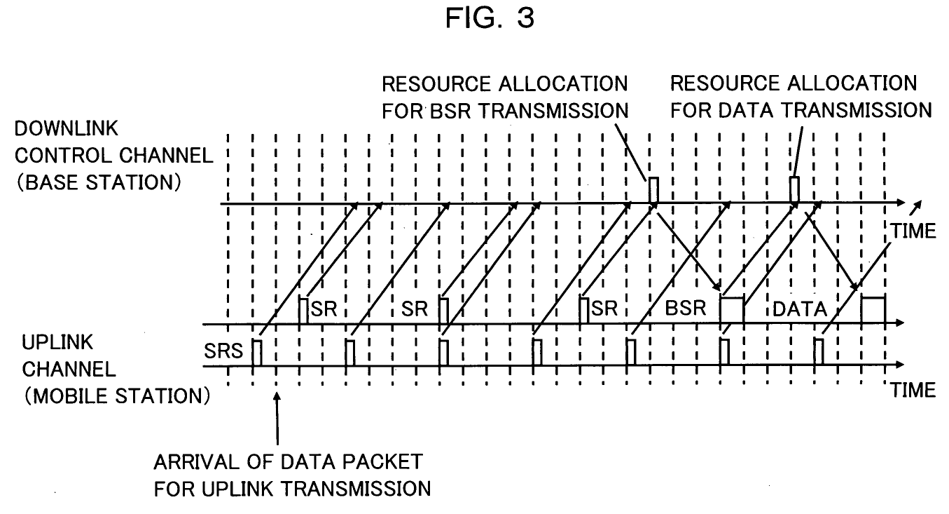

FIG. 3 illustrates a configuration example of a frame used for downlink transmission.

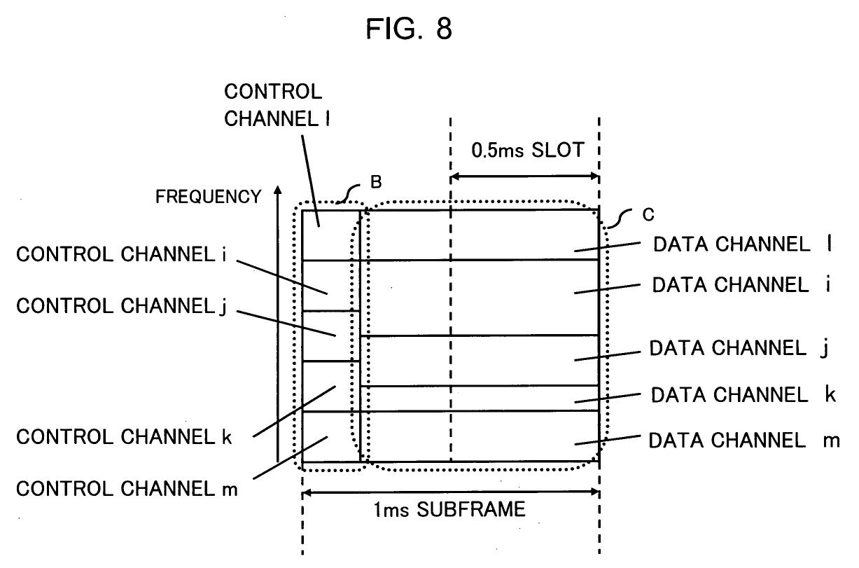

As with the uplink, two 0.5 ms slots are included in one 1 ms sub-frame. At a head part of the first slot, a transmission area of a control channel surrounded by dotted line B (e.g. PDCCH) is provided. Here, five control channels are provided: i, j, k, l, and m. In FIG. 8, the control channels are formed in a gathered frequency area. However, the control channels may be distributed so as not to overlap each other. Each control channel may include ID (Identification) information of mobile station 2. For example, the ID of the mobile station 2 may be included in the control signal or the control signal may be multiplied by the ID.

If the capacity of the control channel is large enough to include a message, the particular signal (e.g. a signal indicating that the radio resource cannot be allocated) may be transmitted in the control channel. Furthermore, of the shared data channels (for example, PDSCH) shown by a surrounding dotted line C, the control channel includes the information for specifying a corresponding data channel (any of i, j, k, l, or m).

For example, the control channel i includes frequency information and transmission parameters (such as modulation scheme and/or (en)coding rate) used for transmission of the data channel i. This allows the mobile station 2 to receive the data transmitted through the data channel i by receiving the control channel i.

Therefore, as an example, when transmitting the particular signal to the mobile station 2, the base station 1 transmits the information (such as frequency information) used to specify the data channel i for data transmission to the mobile station 2 via the control channel i as well as the control signal that includes the ID of the mobile station 2 and the particular signal through the control channel i.

In FIG. 8, allocation order of the control channel and the data channel are matched. However, the order is not necessarily matched.

When the particular signal is transmitted from the base station 1, the mobile station 2 receives the particular signal through the receiving processing unit and relays the received signal to the controller 30.

Since the controller 30 detects that the particular signal is received from the base station 1, the controller 30 performs a certain operation. That is, the controller 30 controls the transmission of the (SR) signal for requesting allocation of a radio resource.

Since the radio source is not allocated from the base station 1 even though the SR as a request for allocating a radio source is transmitted, the control of the retransmission of the SR is usually performed repeatedly. However, in this case, the transmission of the SR is regulated by receiving the particular signal.

The SRS is a signal used for a purpose that is different from that of the SR. When receiving the particular signal, the controller 30 of the mobile station 2 regulates the transmission of the SRS. Therefore, the base station 1 does not have to receive the SRS, observe or analyze the SRS.

In this example, the controller 30 regulates the transmission of the SRS transmitted in the certain period. In FIG. 8, since a second SRS is already transmitted when the certain signal is received, the controller 30 regulates a subsequent transmission of the SRS.

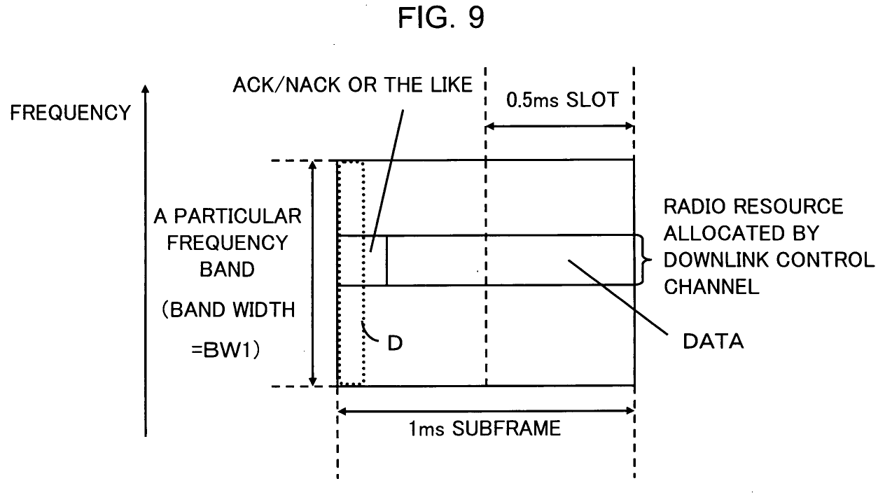

As described above, it is possible to reduce unnecessary transmission of the SR. Furthermore, the SRS, a signal used for a purpose that is different from that of the SR, is used to select the frequency to be allocated to the mobile station 2 by the base station 1 of the particular frequency band (BW (width=BW1)) in FIG. 9. It is possible to reduce the transmission of the SRS by the transmission of the particular signal.

By the transmission of the particular signal, regulation control is performed by the mobile station 2. The present embodiment may include a structure for releasing the regulation as follows.

### “Release of Regulation”

The controller 30 of the mobile station 2 regulates the transmission of the SR by receiving the particular signal and performs the regulation control to regulate the transmission of the SRS. However, the regulation may be released by using an internal timer. For example, when receiving the particular signal, the controller 30 sets a certain time T to the timer. When receiving a notification of the passage of time T from the timer, the controller 30 permits the release of the transmission of the SR and SRS. Preferably, the regulation of the transmission of the SRS is released earlier than that of the SR. The regulation of the transmission of the SRS may be released at the same time as that of the SR. At the allocation of the radio resource in response to the SR, if the base station 1 receives the SRS at the same time as or earlier than the SR, it is possible to perform the allocation reflecting the state of the radio quality. It is preferable that the SRS is received by the base station 1 at the time that is close to the time point of the allocation of the radio resource because the base station 1 may reflect the latest state of the radio quality to the allocation.

The time T is a single value. However, one of a plurality of possible times: T0 to TN (N is a value that is two or more) may be set as a certain time to the timer. Various selective algorithms may be used. The mobile station may generate random numbers to be distributed between mobile stations and set Ti (i is zero or more and less than N) corresponding to a reminder i from the random number divided by N+1 as a certain time to the timer.

Further, the regulation may be released by the arrival of a certain time. For example, each radio frame may be indicated by a number and then the controller 30 may release the regulation when a certain radio frame arrives.

Further, the controller 30 obtains timing information by which the regulation should be released from the base station 1 and then may release the regulation according to the timing information.

For example, the controller 10 of the base station 1 generates and gives a certain signal that includes a back-off time to the transmitting processing unit (transmits the certain signal through the control channel (PDCCH) or the data channel (PDSCH)).

Then the controller 30 of the mobile station 2 detects the back-off time, performs the regulation over the time specified by the back-off time (Tb), and then releases the regulation.

For example, as shown in FIG. 6, the transmission timing interval of the SR may be a starting time, and then the regulation specified by the Tb is performed. The starting time may be another timing interval such as a reception timing interval of the particular signal.

The mobile station 2 detects that the condition of the regulation release is satisfied and then performs transmission of the SR to request an allocation of the radio resource again because there is an uplink data packet to be transmitted.

In this example, the SRS is transmitted from the mobile station 2 earlier in time than the SR.

When receiving the SR, the controller 10 of the base station 1 confirms whether the radio resource may be allocated according to the passage of the regulation time. If it is detected that the allocation of the radio resource may be performed, the controller 10 of the base station 1 generates a signal for allocating a radio resource to transmit a buffer status report signal (BSR) and then makes a transmitting processing unit transmit the signal, so that the amount of bandwidth required for the allocation of the data transmission can be determined. At this time, since the SRS is received from the mobile station 2, the frequency of the radio resource to be allocated may be a part of the frequency that shows a good reception quality by the SRS.

The mobile station 2 finds a buffer amount of the data processor 31 that is also used as a buffer storing data to be transmitted and then reports (transmits the BSR) the buffer amount to the base station 1 by using the allocated radio resource.

By using the BSR or the SRS (the latest SRS or an accumulated SRS), the controller 10 of the base station 1 selects and transmits to the mobile station 2 the required frequency bandwidth and frequency part as the information of the radio resource for the data transmission.

Therefore, the mobile station 2 performs data transmission according to the information of the selected radio resource.

FIG. 9 illustrates a configuration example of the radio frame (in the case when there is the transmission data) used for the uplink transmission.

As illustrated in FIG. 7, the radio sub-frame that includes two slots is used to transmit the data by the radio resource specified by the base station 1. When receiving the downlink data from the base station 1, the mobile station 2 may transmit the reception result (ACK/NACK) or the CQI by time-multiplexing in the data part. The information of the radio resource indicates the radio resource (e.g. frequency) for transmission of DATA as an example.

In the example described above, the transmission regulation of the SRS is released earlier than that of the SR. However, the transmission regulation of the SRS may be released at the same time as or earlier than the transmission of the BSR. This may be used to select the radio resource for the data transmission.

The SRS, the SR, and the BSR are transmitted separately. However, the SR, the BSR, and the SRS may be transmitted at the same time.

If the particular signal is not transmitted from the base station 1 (in the case of silent) even though the SR is transmitted, the mobile station 2 may transmit the SR again without regulating the transmission of the SR or other regulation signals.

Further, after the transmission of the SR, the data is transmitted after the BSR is transmitted. However, the data transmission may be performed by using the radio resource that is allocated to the SR. For example, steps for transmitting the BSR are omitted or the data and the BSR are multiplexed and transmitted.

### “Processing Flow (2)”

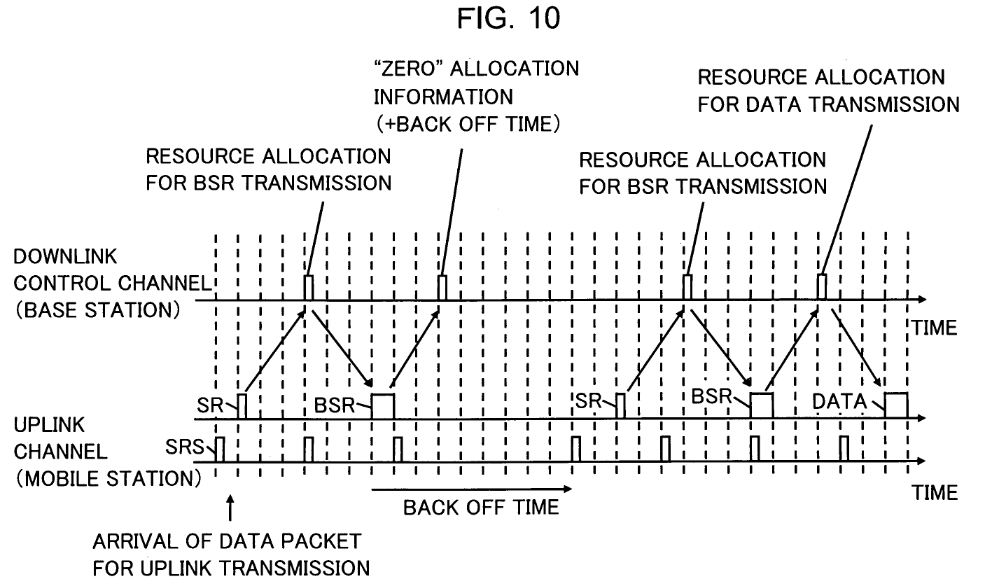

FIG. 10 illustrates a flow of uplink resource allocation and data transmission (2).

In FIG. 6 the base station 1 transmits the particular signal according to the reception of the SR. However, in this case, the base station 1 transmits the particular signal according to reception of the BSR. Other process basically may be the same as the flow of data transmission (1).

That is, when receiving a first SR from the mobile station 2, the controller 10 of the base station 1 determines whether or not the allocation of the radio resource for the transmission of the BSR is possible. If it is determined that the allocation of the radio resource for the transmission of the BSR is possible, the controller 10 of the base station 1 allocates the radio resource for the transmission of the BSR to the mobile station 2, and then transmits the information of the allocated radio resource via the control channel (PDCCH) or the data channel (PDSCH).

The controller 30 of the mobile station 2 detects the information of the allocated radio resource and then transmits the BSR by using the radio resource. However, the controller 10 of the base station 1 determines that it is difficult to allocate the band according to the BSR. The following are possible cases: the case that the situation is changed by the reception of the SR; the case that the data amount to be transmitted is large so that it is difficult to allocate the band corresponding to the data amount; and the case that the transmission has waited for a long period to give preference to other mobile stations because the data amount to be transmitted is small.

In any case, the base station 1 transmits the particular signal because it is difficult to allocate the radio resource for the data transmission to the mobile station 2. The particular signal may be the particular signal described earlier.

The controller 30 of the mobile station 2 performs the regulation control described above and performs the same process by the release shown above.

### “Flow of Processing (3)”

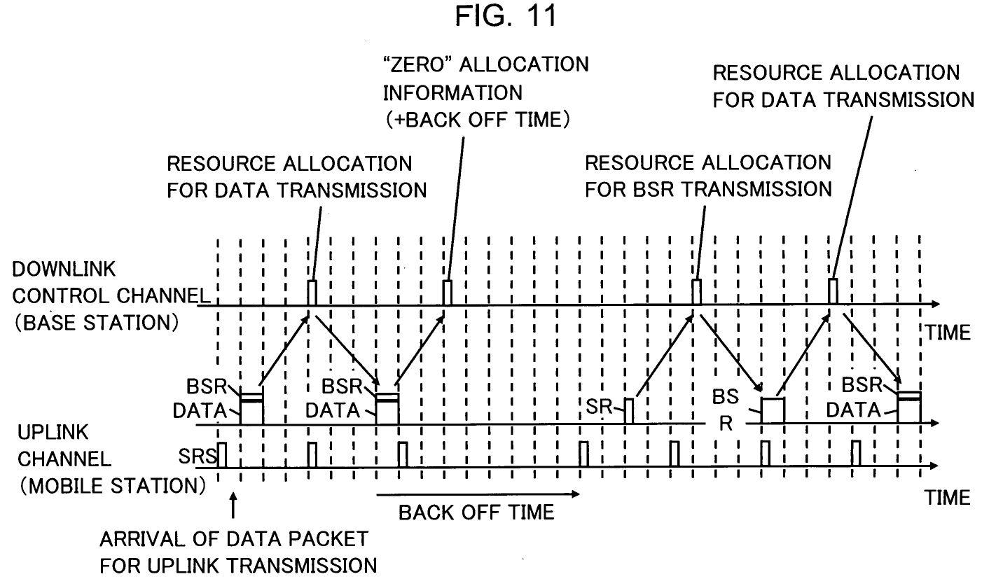

FIG. 11 illustrates a flow of uplink resource allocation and data transmission (3).

In FIG. 6, the mobile station 2 does not perform the data transmission. However, in this example, it is assumed that the mobile station 2 has already performed the data transmission. By multiplying the data by the BSR, it is assumed that the buffer state is reported to the base station. Other process basically may be the same as that of the flow of data transmission (1).

The mobile station 2 periodically transmits the SRS, multiplies the data by the BSR, and performs the multiplexed data transmission by using the radio resource that is allocated by the base station 1.

That is, in the frame illustrated in FIG. 9, the mobile station 2 transmits the data after multiplexing the area shown by DATA by the BSR or storing the BSR in the area shown as ACK/NACK for example.

The controller 10 of the base station 1 decodes the received data by the decoding unit 26, and then performs the error correcting process on the decoding result by using a CRC check bit for example to determine whether or not the reception is successful. If the reception is successful, the controller 10 of the base station 1 generates and gives the ACK signal to the multiplexer 13. If not, the controller 10 of the base station 1 generates and gives the NACK signal to the multiplexer 13.

The controller 10 of the base station 1 selects the radio source for transmitting the new data or the retransmission data to the mobile station 2 according to the ACK/NACK and then transmits the data with the reception result (ACK/NACK) through the control channel (PDCCH) or the data channel (PDSCH) of FIG. 8.

Selection of the radio resource is performed by adjusting the bandwidth to form a radio resource with a required size as well as by selecting a preferable frequency part by the SRS.

The mobile station 2, which receives a reception result and allocation of a radio resource, transmits corresponding data and BSR.

However, in this case, the base station 1 determines that the radio resource cannot be allocated to the mobile station 2 because of the above-described circumstances, and then transmits the particular signal.

The controller 30 of the mobile station 2 receives the particular signal and then regulates the transmission of the SR, the BSR, and the SRS.

The regulation release may use any of the methods described above. In this example, the SRS is transmitted earlier than the SR.

After the regulation is released, a series of processing including such as transmission of SR, allocation of a radio resource for BSR transmission, transmission of BSR, allocation of a radio resource for data transmission, and transmission of multiplexed data including data and BSR are performed.

### “Flow of Processing (4)”

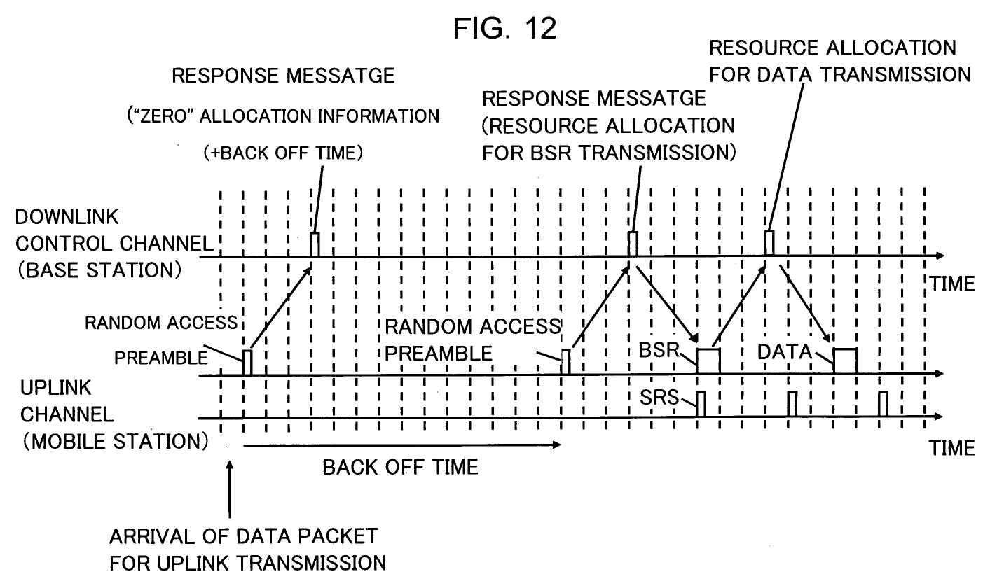

FIG. 12 illustrates a flow of uplink resource allocation and data transmission (4).

In FIG. 6, the mobile station 2 already obtains a physical uplink control channel for transmitting the SR. However, in this case, when the mobile station 2 does not obtain the physical uplink control channel for transmitting the SR, it first performs the transmission of the random access signal.

Other processes may be basically the same as that of the flow of the data transmission (1).

First, the controller 30 of the mobile station 2 generates a preamble as a random access signal that is transmitted through a random access channel and then transmits the preamble from the transmitting processing unit.

The random access signal is a signal transmitted when the communication with the base station 1 starts. For example, the random access signal is transmitted in a transmission region (transmission resource) of the random access signal shared with other mobile stations.

In this example, the random access signal is received by the base station 1. The base station 1 determines that it is difficult to allocate the radio resource for transmitting the BSR (SR) because of the circumstances described above and then transmits the particular signal.

The controller 30 of the mobile station 2 receives the particular signal and then performs the regulation process.

In this case, an object of the regulation may be the transmission of the random access signal, the transmission of the SRS, and so on.

A condition of the regulation release may use any of the above conditions. However, the release of the transmission regulation of the SR is replaced with the release of the transmission regulation of the random access signal when applying the condition described above.

In this example, the condition of the regulation release is satisfied such that the controller 30 of the mobile station 2 first retransmits the random access signal.

At that time, when receiving the random access signal, the controller 10 of the base station 1 confirms whether or not the radio resource may be allocated to the mobile station 2 (whether there is space in the allocation state of the radio resource). If the radio resource may be allocated, the controller 10 of the base station 1 notifies the mobile station 2 of the information of the selected radio resource by selecting the radio resource for the BSR transmission.

Because the mobile station 2 is allocated the radio resource for the BSR transmission, the mobile station 2 transmits the BSR by using the radio resource. Furthermore, by being allocated the radio resource for the data transmission from the base station 1, the mobile station 2 transmits the data. As with the above example, the data may be multiplexed by the BSR, and then transmitted.

In this example, the SRS is not transmitted after the transmission regulation of the random access signal is released. The transmission of the SRS starts after receiving a response from the base station 1 in response to the random access signal.

The transmission of the SRS can be started earlier than transmission of the BSR independently from the transmission of the BSR. The transmission of the SRS may be performed in a certain period by using a part of A illustrated in FIG. 7 (a slot, for instance,) in which the SRS transmitted is specified as a response signal (that includes the allocation of the radio resource for the BSR transmission) of the random access signal from the base station 1). In this case, however, the transmission of the SRS is performed at the same time as the transmission of the BSR.

Referring to FIG. 9, the SRS is transmitted in a part of D surrounded by a dotted line, and the part shown by the DATA is shortened by one symbol. The BSR is transmitted in the part shown by the DATA. The signal such as ACK/NACK may not be transmitted, or may be time-multiplexed on the DATA part to prevent overlapping of the SRS.

In this example, the base station 1 allocates the radio resource for the BSR transmission to the mobile station 2 in respond to the random access signal. However, the base station 1 may allocate the PUCCHi of FIG. 7, and then the mobile station 2 may transmit the SR first by using the PUCCHi as illustrated in FIG. 6.

If the particular signal is not transmitted from the base station 1 even though the random access signal is transmitted (in the case of silent), the mobile station 2 does not regulate the transmission of the random access signal, for example, and may retransmit the random access signal.

### “Flow of Processing (5)”

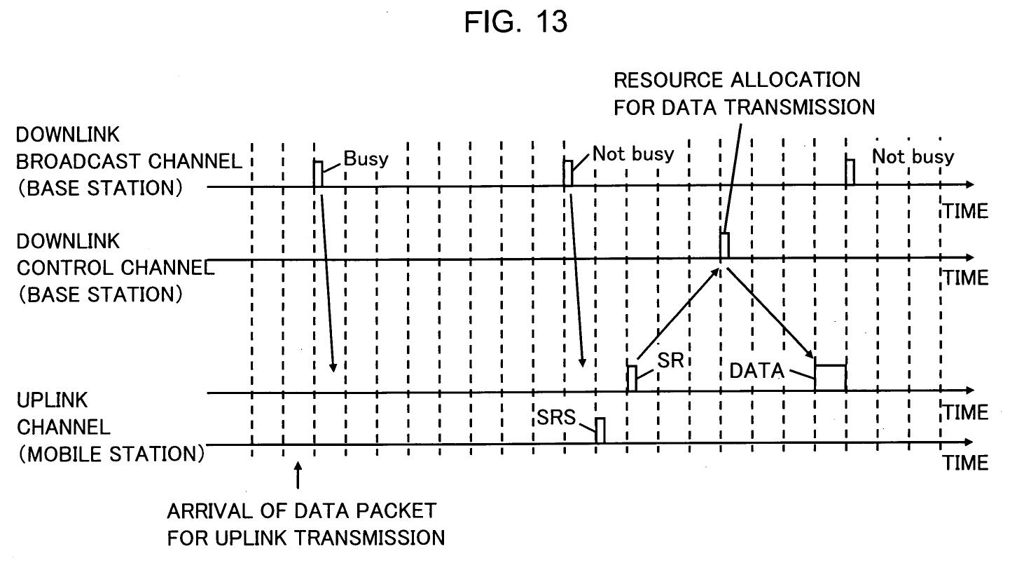

FIG. 13 illustrates a flow of uplink resource allocation and data transmission (5).

In the example described above, the base station 1 transmits the particular signal in response to reception of the SR, the BSR, and the random access signal. However, in this case, the base station 1 transmits the particular signal as a broadcast signal.

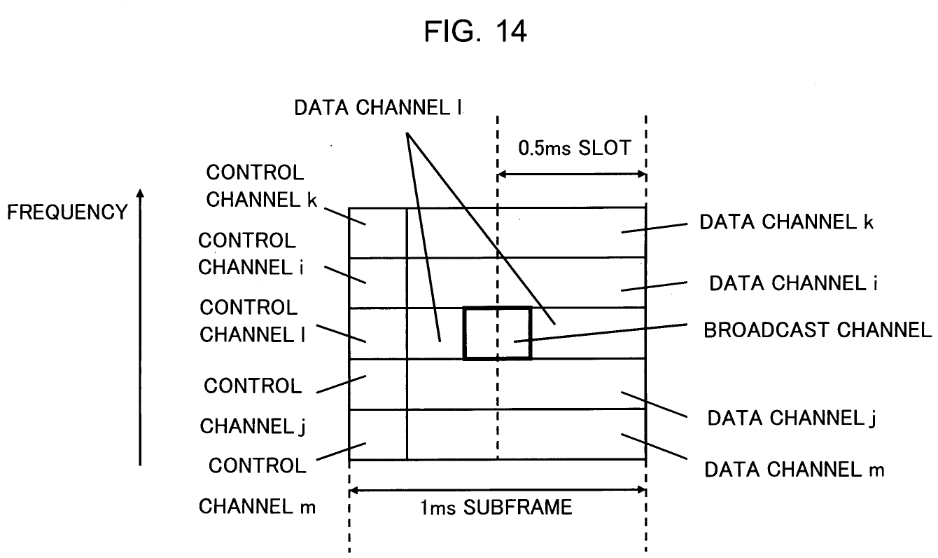

FIG. 14 illustrates a configuration example used for downlink transmission (2).

At the center of the frequency band used for transmission, a frame provides a broadcast channel that has a center at a boundary part of the slot and provides data channels i, k, j, and m at the upper and lower parts of the broadcast channel and data channel l in the same frequency band. The control channel includes each transmission frequency of the data channels i, j, k, l, and m, and the information that may specify the transmission parameter, respectively.

The broadcast channel is a channel for transmitting the information to be notified to a plurality (entirety) of the mobile stations in a cell included in the base station 1 and may transmit the radio resource information in which the above-described random access signal is transmitted.

In this example, this broadcast information includes the particular signal.

That is, by generating the particular signal as a part of the broadcast information and relaying the particular signal to the multiplexer 13, the controller 10 of the base station 1 transmits the particular signal.

When receiving the particular signal as the broadcast information by periodically receiving the broadcast information, the mobile station 2 regulates the transmission of the SRS as described above even though there is an uplink packet data to be transmitted.

Accordingly, the regulation control may be performed on a plurality of mobile stations all at once. However, in another embodiment a mobile station that is already allocated a radio resource for the data transmission or for the BSR transmission does not have to perform the regulation control even after receiving the particular signal.

Following reception of the particular signal if the particular signal is not detected in a following broadcast of the broadcast information (for example, receiving in the next period of the broadcast channel reception), the controller 30 of the mobile station 2 releases the transmission regulation of the SRS and releases the transmission regulation of the SR and then transmits the SRS and the SR, respectively. Here, the SRS is periodically transmitted separately from the SR.

After receiving the SR, the base station 1 selects the radio resource to be allocated based on the SRS, for example, and transmits the information of the allocated radio resource through the downlink channel.

Therefore, the controller 30 of the mobile station 2 transmits the data by the frequency part in which the data is transmitted according to the information of the allocated radio resource.

As illustrated in FIG. 6, the base station 1 may allocate the radio resource for the BSR transmission first and then may allocate the radio resource for the data transmission later on.

### “Flow of Processing (6)”

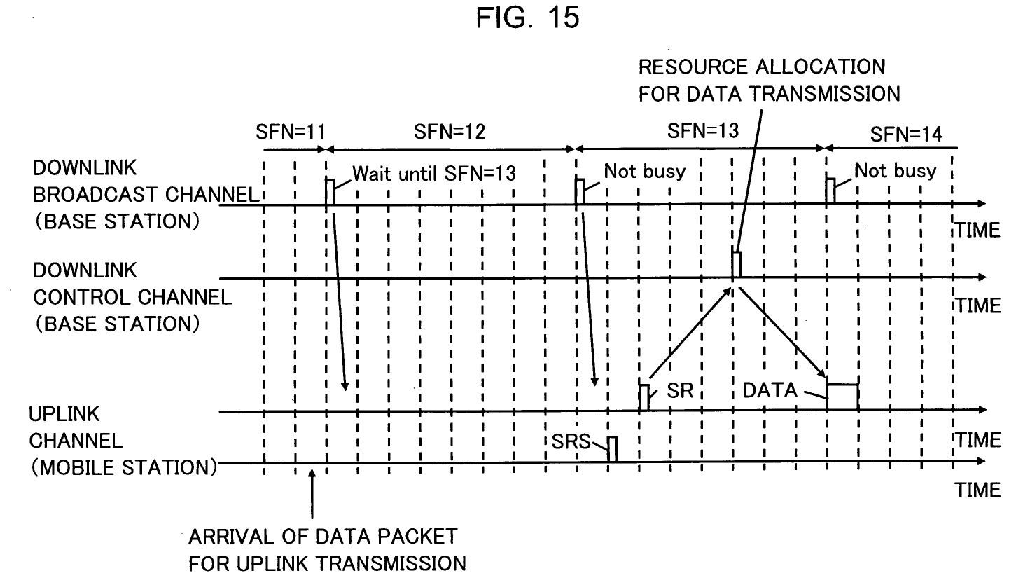

FIG. 15 illustrates a flow of uplink resource allocation and data transmission (6).

The radio frame is indicated by a system frame number (SFN) The broadcast information is used to allow the mobile station 2 to specify the number of the radio frame by periodically transmitting the frame number while updating.

At the time of transmitting the particular signal, the controller 10 of the base station 1 additionally transmits certain timing information (for example, the timing at which an SFN 13 starts) and then instructs the mobile station 2 to perform control process by the certain timing information.

Therefore, by receiving the particular signal, the mobile station 2 regulates the transmission of the SRS and the SR even though there is an uplink packet to be transmitted.

Then the mobile station 2 again performs the reception of the notification information channel at the timing of the radio resource at which the SFN 13 is transmitted. After receiving the particular signal, the power of the receiving process may be turned off until the SFN 13 arrives. However, if the reception is such that it is intermittent, a separate reception is necessarily performed.

The mobile station 2 receives the radio frame of the SFN 13 and then detects that the particular signal is not transmitted (detects that the allocation of the radio resource may be performed) as the broadcast information. Then the mobile station 2 releases the transmission regulation of the SRS and SR and then performs the transmission of the SRS and the transmission of the SR. The SRS may be transmitted at the same time as the SR. In this case, however, the SRS is transmitted earlier.

After receiving the SR, the base station 1 selects the radio resource that is allocated based on the SRS, for example, and then transmits the information of the allocated radio resource through the physical downlink control channel.

Accordingly, according to the information of the allocated radio resource, the controller 30 of the mobile station 2 transmits the data in the frequency part by which the data should be transmitted.

As illustrated in FIG. 6, the base station 1 may allocate the radio resource for the BSR transmission and then may allocate the radio resource for the data transmission.

The mobile station that is already allocated the radio resource for the data transmission or for the BSR transmission does not have to perform the regulation control after receiving the certain signal in another embodiment.

The flows of each processing 1 to 6 described above may be combined for use.

According to the embodiment described above, it is possible to control the transmission of the radio signal for requesting radio resource allocation. Further, according to the embodiment described above, it is possible to control the transmission of the radio signal used to select the radio resource.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present inventions have been described in detail, it should be understood that the various changes, substitutions, and alterations could be made hereto without departing from the spirit and scope of the invention.

What is claimed is:

1. A control method for a radio communication system, wherein a second communication apparatus receives a radio signal for requesting allocation of a radio resource from a first radio communication apparatus, the second radio communication apparatus selects a radio resource to be allocated to the first radio communication apparatus based on a radio signal used to select the radio resource and transmits information of the selected radio resource to the first radio communication apparatus, and the first radio communication apparatus transmits transmission data by using the radio resource specified by the information, the control method comprising:
regulating transmission of the radio signal used to select the radio resource to be allocated when the first radio communication apparatus receives a particular signal from the second radio communication apparatus.

2. The control method according to claim 1, wherein the radio signal used to select the radio resource is either a pilot signal transmitted by using a plurality of frequencies in a particular frequency band or a radio signal which shows a buffer status in the first radio communication apparatus.

3. The control method according to claim 1, wherein the second radio communication apparatus transmits the certain signal in response to a reception of the radio signal for requesting allocation of the radio resource.

4. The control method according to claim 1, wherein the second radio communication apparatus transmits the particular signal as broadcast information.

5. The control method according to claim 4, wherein the particular signal is a signal transmitted in a state in which the radio resource cannot be allocated, and
when the first radio communication apparatus receives a signal notifying that a radio resource can be allocated from the second radio communication apparatus, the first radio communication apparatus releases the regulating of the transmission of the radio signal.

6. The control method according to claim 4, wherein the particular signal is a signal transmitted in a state in which the radio resource cannot be allocated and includes a prospective timing interval during which the state that the radio resource cannot be allocated changes, and
when the first radio communication apparatus receives broadcast information indicating that a radio resource can be allocated from the second radio communication apparatus at the prospective timing interval, the first radio communication apparatus releases the regulating transmission of the radio signal.

7. The control method according to claim 1, wherein the signal used to select the radio resource is a pilot signal transmitted by using a plurality of frequencies in a particular frequency band, and
when the first radio communication apparatus receives the particular signal from the second radio communication apparatus, the first radio communication apparatus regulates the transmission of the signal for requesting allocation of a radio resource, and
the regulation of the transmission of the radio signal used to select the radio resource is released at the same time as the regulation of the transmission of the signal for requesting allocation of the radio resource or at an earlier time interval or is released at the same time as transmission of a report signal of a buffer amount or at an earlier time interval.

8. A radio communication apparatus corresponding to a first radio communication apparatus in a radio communication system in which the first radio communication apparatus transmits a radio signal used to select a radio resource to a second radio communication apparatus, and when the second radio communication apparatus receives a radio signal for requesting allocation of a radio resource, the second communication apparatus selects a radio resource to be allocated from a particular frequency band based on the radio signal used to select the radio resource, and then the first radio communication apparatus transmits transmission data by using the radio resource specified by the information of the radio resource, the radio communication apparatus comprising:
a controller configured to regulate the signal used to select a radio resource to be allocated when the radio communication apparatus receives a particular signal from the second radio communication apparatus.

9. A radio communication apparatus corresponding to a second radio communication apparatus in a radio communication system in which a first radio communication apparatus transmits a radio signal used to select a radio resource, and when the second radio communication apparatus receives a radio signal for requesting allocation of a radio resource from the first radio communication apparatus, the second radio communication apparatus selects a radio resource to be allocated based on the radio signal used to select the radio resource, and the second radio communication apparatus transmits information of the selected radio resource to the first radio communication apparatus, and the first radio communication apparatus transmits transmission data by using the radio resource specified by the information of the radio resource, the radio communication apparatus comprising:
a transmitter configured to transmit a particular signal to the first radio communication apparatus to notify the first radio communication apparatus to regulate the radio signal used to select the radio resource to be allocated.

10. A control method in a radio communication system where a second radio communication apparatus receives a radio signal for requesting allocation of a radio resource from a first radio communication apparatus, the second radio communication apparatus selects a radio resource to be allocated and transmits information of the selected radio resource to the first radio communication apparatus, and the first radio communication apparatus transmits transmission data by using the radio resource specified by the information of the radio resource, the control method comprising:
transmitting a particular signal from the second radio communication apparatus according to an allocation state of the radio resource; and
regulating transmission of the radio signal for requesting allocation of the radio resource when the first radio communication apparatus receives the particular signal.

11. The control method according to claim 10, wherein the second radio communication apparatus transmits the particular signal when there is no radio resource that can be newly allocated.

12. The control method according to claim 10, wherein the regulation is not performed until a limit based on any time included in one or a plurality of time candidates.

13. The control method according to claim 10, wherein the particular signal includes timing information at which the regulating transmission of the radio signal should be released, and the second radio communication apparatus releases the regulating transmission of the radio signal according to the timing information.

14. The control method according to claim 10, wherein the second radio communication apparatus transmits the particular signal in response to reception of either a random access signal or a scheduling request signal.

15. The control method according to claim 10, wherein the signal for requesting allocation of the radio resource is either a random access signal or a scheduling request signal.

16. A radio communication apparatus corresponding to a first radio communication apparatus in a radio communication system in which the first radio communication apparatus transmits a radio signal for requesting allocation of a radio resource to a second radio communication apparatus, and when the second communication apparatus receives a radio signal for requesting allocation of a radio resource from the first radio communication apparatus, the second radio communication apparatus selects a radio resource to be allocated and then transmits information of the selected radio resource to the first radio communication apparatus, and the first radio communication apparatus transmits transmission data by using the radio resource specified by the information of the radio resource, the radio communication apparatus comprising:
a receiver configured to receive a particular signal transmitted from the second radio communication apparatus according to an allocation state of the radio resource; and
a controller configured to regulate the signal for requesting allocation of the radio resource when the particular signal is received by the receiver.

17. A radio communication apparatus corresponding to a second radio communication apparatus in a radio communication system in which a first radio communication apparatus transmits a radio signal for requesting allocation of a radio resource to the second radio communication apparatus, and when the second radio communication apparatus receives a radio signal for requesting allocation of a radio resource, the second radio communication apparatus selects a radio resource to be allocated, and then transmits information of the selected radio resource to the first radio communication apparatus, and the first radio communication apparatus transmits transmission data by using the radio resource specified by the information of the radio resource, the radio communication apparatus comprising:
a transmitter configured to transmit a particular signal according to an allocation state of the radio resource; and
a receiver configured not to receive a signal for requesting allocation of a radio resource from the first radio communication apparatus during a predetermined time relating to the transmission of the particular signal.
